(19) United States
(12) Patent Application Publication
(10) Pub. No.: US 2020/0394278 A1
(43) Pub. Date: Dec. 17, 2020

(54) Hybrid Finite Element and Artificial Neural Network Method and System for Safety Optimization of Vehicles

(71) Applicant: Abraham Varon-Weinryb, Waltham, MA (US)

(72) Inventor: Abraham Varon-Weinryb, Waltham, MA (US)

(21) Appl. No.: 16/442,422

(22) Filed: Jun. 14, 2019

(51) Int. Cl. G06F 17/50; G01M 5/00; G06N 3/04; G05D 1/00; G06F 17/18; G06N 3/12

(52) U.S. Cl. CPC G06F 17/5018; G06F 17/5095; G01M 5/0033; G06N 3/126; G05D 1/0055; G06F 17/18; G06N 3/04

(57) ABSTRACT

The present invention relates to a method for optimizing vehicles' design in terms of safety during crash situations, using a hybrid approach that combines analyzed data such as Finite Element data with methods from the AT fields, comprising the steps of: (a) collecting design data sets which include analyzed data; (b) collecting safety data of existing cars' models; (c) creating an Artificial Neural Network which learns how to predict safety data based on design data sets; (d) creating an optimizer which uses the neural network as a simulator and finds optimized values for design data sets of a new car's design; (e) performing a recurring process of design data set's update, until all parameters of the design data set get their optimized final values.

### FIELD OF THE INVENTION

The field of the invention relates to a method and system for design optimization of vehicles. More particularly, the invention relates to a method and system for simulation of regular or autonomous vehicles, as part of the vehicle's development and design process, for the purpose of optimizing the vehicle in terms of safety during various crash situations and providing higher protection to the passengers of the car, as well as to surrounding cars and pedestrians. The invention combines a finite element analysis, an artificial neural network model, and a genetic algorithm. The invention introduces more functionality, more accuracy and faster performance comparing to any existing methods. Moreover, the invention can reveal dormant correlations between a car's design parameters and its expected safety. Such parameters relate not only to a car structure's strength, elasticity and durability, but also to many other potentially relevant, yet unknown, aspects of safety which may influence the outcomes of real-world car crash situations.

### BACKGROUND OF THE INVENTION

A milestone phase and an essential part of any new car's development are crash tests. During this series of tests, prototypes of a new car's model are tested for crash situations, using cameras, sensors attached to the car and sensors attached to dummies which represent the car's driver and passengers, as well as pedestrians.

Regulations at most modern countries require a minimum score result for crash tests of new models, in order to obtain licensing to sell such new models. Of course, the highest possible score is preferred, but in many cases the score is somewhere between the minimal required score and the highest possible score. The crash tests are carried out once a prototype has been designed and manufactured. This is a very late stage of the development cycle, therefore it is not feasible in terms of cost and time-to-market to redesign, remanufacture and retest a car in order to optimize its safety, unless the tests results are unacceptable.

Another limitation of such tests is that the safety scores are not based on any real-world data, but only on the test itself. Statistics of the real safety of a specific model will be available only months and years after cars of such model are being sold and used on the roads. The tests try to emulate the real world, but there will always be fundamental differences. In addition, the measuring equipment and methods have their own inaccuracies.

Yet another limitation of a crash test is that it does not and cannot provide safety data relating to other cars that might be involved in the real-world crash situation of the tested car. Such information would be valuable, because if the tested car is safer to its surrounding cars during a crash situation, without compromising the safety of the tested car itself—than more lives could be saved, and more injuries could be avoided or reduced.

Since, as said, crash tests are carried out at a very late design phase, cars manufacturers also perform crash simulations at an earlier design phase. This is enabled using existing simulation software, mainly based on finite element analysis. However, such simulation is extremely complicated and has many limitations. A finite element analysis of a car crash is one of the most challenging application of structural finite element analysis. A car crash simulation requires a very complex dynamic analysis, which is also non-linear in many aspects: (a) nonlinear material behavior of metal parts which exceed their yield point; (b) nonlinear materials such as plastic parts; (c) nonlinearity of large displacements which requires updates to the model's stiffness matrix and mass matrix ; (d) nonlinear contact analysis using gap elements. Such highly dynamic and nonlinear simulation needs to be applied to a very complex 3D model of a car assembly, resulting in a very large finite element model. Such model may need to include millions of equations. Other complexity aspects of such model may involve the obvious need to use and combine various finite element types such as volume elements, surface elements, line elements, scalar elements and special elements such as rigid body elements, as well as the need to use complex materials and their related failure criteria. The boundary conditions and loads definitions of such model are also very complicated. It is difficult to define the related frequency-dependent damping coefficients, which are critical to the dynamic behavior of the model during a transient dynamic analysis.

As a result, such a model is both very large and very complicated. Yet, it is still a must to include some assumptions and simplifications to such model, which affect its accuracy.

Indeed, existing simulation tools are limited in functionality and in use. They require a massive expert's work during the preprocessing phase, and long runtime during the solver's phase. The results of such significant investment are limited. The accumulative inaccuracies of such simulation might be huge. The differences between such simulation results and the real-world data are big—typically much bigger than the differences between the prototype's crash tests and real-world data. The finite element simulation represents the engineering input data which is translated into mathematical equations, and such simulation does not correspond with real-world data, which will be available only months and years after the simulated model is manufactured, sold and commonly used.

In addition, and similar to limitations of crash tests, such existing simulation methods do not and cannot predict how the simulated design affects the safety of surrounding cars and their passengers during crash situations, in which the simulated car and such surrounding cars are involved.

Another existing approach of a specific crash-oriented simulation is the macro-element method. Using a semi-empiric approach and a simplified modeling method, it enables a faster simulation which can be applied to a more conceptual design. However, there are too many limitations, assumptions and inaccuracies, and this method is less useful and less accurate comparing to the finite element method.

Some of the complex finite element processes have been enhanced in terms of accuracy, work effort and functionality, by introducing special finite element modules, which are specific to crash tests. Such modules automate some of the preprocessing to shorten the simulation time. They also enhance the solvers to be better calibrated for the high impact dynamic transient response analysis involving a car crash. Yet, the above-mentioned main limitations of functionality and accuracy still very much exist for these specific modules as well.

The physical crash testing procedures have also been significantly enhanced during the last decades, by adding more testing scenarios such as side crash tests and rollover crash tests, by enhancing such tests from time to time, to make them closer to the real-world, and by regulating and standardizing the safety scores system, to make it easier to compare various cars of different manufacturers. However, and just like with the crash simulation software limitations, there are both accuracy and functionality limitations to physical crash tests, that cannot be eliminated.

Another common limitation of both existing crash tests and existing methods of crash simulation is the inability of such methods to reveal dormant correlations between a car's characteristics and the related impact of such characteristics on the human body during crash situations.

It is therefore an object of the present invention to provide a simulation method and system for simulating car crash situations and the related safety anticipated, which provide results that are more accurate and closer to the real-world, comparing to any existing simulation software.

It is therefore an object of the present invention to provide a simulation method and system for simulating car crash situations, which will be, in many cases, closer to the real-world data even comparing to physical crash tests.

It is therefore an object of the present invention to provide a method and system for simulation of car crash situations, which utilizes Artificial Intelligence approach, including Artificial Neural Network (also referred to as just neural network) and a Genetic Algorithm, and effectively combine finite element analyses with such algorithms from the AI field.

It is still an object of the present invention to provide such simulation, which also requires less preprocessing time and runtime comparing to any existing simulation methods, although the results are expected to be more accurate and more comprehensive comparing to such existing methods.

It is still an object of the present invention to provide a simulation for car safety during crash situations, which also relates to the safety of passengers of adjacent cars which are involved in such crash, and not limited only to the passengers of the simulated car or nearby pedestrians.

It is still an object of the present invention to enable car manufacturers to use such simulation in order to optimize new car's designs, and to manufacture cars that, as a result of using said simulation, will gain higher safety scores during crash tests.

It is still an object of the present invention to enable car manufacturers to use such simulation in order to introduce safer cars which, as a result of using such simulation, are expected to save lives and reduce injuries during real-world crash situations.

It is still an object of the present invention to enable car manufacturers to use such simulation at a very early stage of the car's design phase.

It is still an object of the present invention to reveal hidden and unknown correlations between a car's characteristics and the related impact of such characteristics on the human body during crash situations.

Other objects and advantages of the present invention will become apparent as the description proceeds.

### SUMMARY OF THE INVENTION

The invention relates to a computer implemented method for optimizing vehicles' design in terms of safety, comprising the steps of: (a) collecting design data sets which include values of design parameters of existing cars' models and values of parameters of related analyzed data; (b) collecting safety data sets of safety parameters' values of said cars' models; (c) creating an artificial neural network, such that values from said design data sets are used for the input layer and values from said safety data sets are used for the target output layer, such that the neural network learns how to reach from said input to said output, within predefined tolerances' values; (d) creating an optimizer in which the input is a new design data set, to be used for a new car's design, and defining ranges of possible values for such new data set, and defining safety goals based on said safety parameters, and using said neural network as a simulator, in order to find optimized values for said new design data set in terms of expected safety of said new car; and (e) based on such optimized values of said new design data set, performing a recurring process of freezing parameters' values and updating said new car's design, until all said optimized values are implemented in such new design.

Preferably, the design data sets include direct design parameters.

Preferably, the design data sets include calculated design parameters.

Preferably, the analyzed data includes data of structural finite element analysis.

Preferably, the finite element analysis includes specific postprocessing operations in order to obtain discrete parameters' values that can be used in said neural network's input layer;

Preferably, the process of freezing parameters' values and updating the design accordingly includes one iteration relating to said direct parameters' values and a second iteration relating to the said analyzed data.

Preferably, the process of freezing parameters' values and updating the design accordingly includes one iteration relating to said direct parameters' values, a second iteration relating to said calculated parameters' values, and a third iteration relating to said analyzed data.

Preferably, the process of freezing parameters' value and related design update is a recurring process which repeats itself until all parameters get their optimized final values.

Preferably, the design data sets include dimensions, physical properties and material properties.

Preferably, the design data sets include design features.

Preferably, the method reveals dormant correlations between said design data sets and a car's safety.

Preferably, the method reveals unknown correlations between design data sets and the impact of a crash situation on the human body.

Preferably, the safety data sets include crash test safety scores.

Preferably, the safety data sets include real-world statistics data relating to safety of said cars' models and pedestrians during crash situations;

Preferably, the safety data sets include real-world statistics data relating to safety of said cars' models and of passengers of adjacent vehicles during crash situations;

Preferably, the range of possible values in the optimizer is narrowed to a constraint definition of a fixed value which is a design must.

Preferably, the safety goals refer to crash test scores.

Preferably, the safety goals refer to crash statistics data of real-world safety during crash situation.

Preferably, the weights of said neural network are being updated using a gradient decent method.

Preferably, the weights of said neural network are being updated using a genetic algorithm method.

Preferably, a specific parameter of said design data sets will be excluded from said input layer of the neural network if such parameter's values are not continuous, and such resulted reduced-size neural network will be duplicated to the number of such non-continuous values, and each of the duplications will be adjusted to a different specific value from the group of said non-continuous values, based on a subset of said design data sets associated with such value, so it can be later used by said optimizer for a new car's design which has such specific value of said specific parameter.

Preferably, the design data sets include present and past cars' models.

Preferably, the optimizer uses a genetic algorithm.

Preferably, the optimizer uses a gradient decent algorithm. Preferably, the optimizer uses a brute force algorithm.

Preferably, the analyzed data includes simulated data of macro element analysis.

Preferably, the analyzed data includes simulated data of thermal finite element analysis.

Preferably, multiple optimization sessions will be performed during a new car's design cycle, each is based on existing partial design data set available at the time, such that said optimizer provides optimized design recommendation towards the next design phase, and towards such next optimization session, which will use an extended design data set.

### BRIEF DESCRIPTION OF THE DRAWINGS

In the drawings:

FIG. 1A is a generic flow diagram of the invention, illustrating the learn phase of the method;

FIG. 1B is a generic flow diagram of the invention, illustrating the optimization phase of the method;

FIG. 2 illustrates a specific example, which utilizes both a modal finite element analysis and a nonlinear transient dynamic finite element analysis, as well as major dimensions and some other features and parameters, for the purpose of obtaining design input data that will result in the highest possible frontal, side and rollover crash test scores;

FIG. 3 illustrates a specific example, which utilizes a modal finite element analysis, as well as frontal dimensions and some other features and parameters, for the purpose of obtaining design input data that will result in both the highest possible pedestrians' safety test score, and the highest possible statistics-based safety score for adjacent cars' passengers during crash situation in which the simulated car is involved;

FIG. 4 illustrates a specific example, which utilizes both analyzed natural frequencies data and qualitative strain energy data obtained from a modal finite element analysis, as well as a minimal set of additional dimensions, features and parameters, for the purpose of obtaining design input data that will result in the highest possible statistics based rollover crash safety score;

### DETAILED DESCRIPTION OF PREFERRED EMBODIMENTS

As said, the current existing methods for simulation of crash safety require significant resources but provide limited results. Safety of cars is a top priority in modern society and is an open issue with constantly increasing severe consequences. This field strives for better solutions. The current invention presents a new approach which will both lead to higher safety and yet will reduce time and cost of a new car's design cycle. In addition, the simulation introduced in this invention provides more functionality comparing to existing methods of simulation and testing. Such new functionality includes (a) the ability to design a car which is also safer for passengers of other cars; (b) the ability to bypass test safety scores and optimize a new car's design with a direct reference to statistically determined real-world crash safety data; and (c) the ability to reveal dormant correlations between a car's design parameters and the resulted car's safety, and to optimize the car's safety based on such previously unknown correlations.

The invention capability to reveal dormant relations between design parameters and expected safety relate to (a) the ability to reveal unknown correlations relating to a car structure's strength, durability and elasticity; (b) the ability to reveal correlations which exceed such obvious characteristics of strength, durability and elasticity, and in particular the ability to expose unknown correlations between a car's design and resulted consequences to a human body during crash situation. It is the persons inside the car that need to be protected, not the structure itself. Since a human body is involved, safety may relate to many hidden and unknown relations and connections. Various geometry proportions are one example. Suppose, just as a hypothetical example, that there is a correlation between the length to height ratio of a car and the safety of the passengers inside it. If such correlation exists, this invention will reveal it and provide design guidelines accordingly.

There are many such possible correlations, waiting to be revealed. Another example relates to possible new aspects, not yet revealed or explored, of a correlation between passengers' safety and the natural frequencies of a car. There are several known-already aspects of a car's natural frequencies which relate to safety. But this invention may reveal other, unknown aspects. The known aspects of a car's natural frequencies include (a) the impact of natural frequencies on the dynamic behavior of the car's structure, and possible amplification of deformations, stresses and strains, and (b) a possible correlation to safety, which is a result of the influence of the car's natural frequencies on the human body due to interaction with the natural frequencies of the human body itself. Indeed, existing methods of testing or finite element analyses can find both the dynamic structure's behavior relating to natural frequencies, and possible effects relating to said correlation between the car natural frequencies and the human body's natural frequencies. But what if the human body is sensitive to the natural frequencies of a car in a way that has nothing to do with the elasticity equations and with resonance or damping phenomena? Theoretically, the vibration of a car at a specific frequency range might influence a human body due to some unknown biological related reasons, which have nothing to do with the elasto-plastic behavior of mechanical or biological structures. Such connections can never be reveled using testing with dummies since they have no biological properties. Such connections also can never be reveled using any finite element analysis, since such analysis is based on and limited to the elasticity equations and related solid mechanics theories. In fact, such connections can never be reveled using any existing method whatsoever. However, such hidden relations can be exposed using this invention. So, just as a hypothetical example, suppose that a car's first non-rigid-body natural frequency which is lower than 29.4 Hz is related to more danger and more severe injuries to people, due to some unknown impact of frequencies of such range on the human body. In case of such hypothetical case, this invention will reveal it, and will provide design instructions accordingly.

It should be emphasized that resonance influence, amplification influence, or any other known aspects of the natural frequencies will also be revealed by the method of the invention, however said other influences which cannot be revealed by any existing simulation or testing will also be revealed by the invention.

Yet another example, of said possible hidden correlations to safety, relates not to a parameter of a dimension or of a physical property, but to a design feature: drive system. Is there a difference, in terms of passive safety, between AWD (All Wheel Drive) system in which the motor power is provided to all wheels and FWD (Front Wheel drive) system where the power is provided to the front wheels only? As said, this discussion relates to passive safety. It does not relate to the possible ability to actively avoid a crash situation due to a superior drive system. The questions asked in this example are: (a) if two cars face the exact crash scenario, does a difference between the drive systems affects the consequences to the passengers' safety, for whatever reason? And (b): if so, are there any design adjustments that should be associated with the chosen drive system, for the goal of increased and optimized safety?

The list of such hidden connections is theoretically endless, but experts in the related fields can make some initial intelligent guesses which make sense. It is also a matter of common sense, and not necessarily an expert's task, to think about input parameters that might influence the optimization goals. For example, if the simulation goal is to find pedestrian safety, it makes sense to explore the influence of frontal dimensions such as Hood Height or Front Overhang, as will be farther demonstrated in example 2. However, if some of said initially-guessed parameters or connections turn out to be irrelevant—no harm is done. According to the method of the invention, such irrelevant parameters will be practically ignored while the other, relevant parameters, will be revealed. The simulation method of this invention will explore such possible connections and will be able to reveal if indeed the suggested parameters are of importance, and, if they are indeed important to safety, the method will be able to advise for the required values for such parameters, per each specific new design. It should be noted that parameters can be added or removed as needed, as the method is flexible and modular.

One of the sources of input data for the simulation method of the invention is a finite element analysis, which is the only way to obtain parameters like natural frequencies or Von-Mises stresses, at an acceptable accuracy, during the design phase, before a physical prototype is available. However, as said, traditional approach of taking this path alone has significant limitations. A finite element analysis by itself cannot predict the safety of a human body during a car crash. The first reason relates to the complexity of a car crash problem. As said, a highly complicated and detailed finite element model of the car's assembly, together with difficult-to-define constraints of such highly dynamic and non-linear problem, are required, and yet limited results are expected.

In addition, it should be emphasized that a direct correlation between such finite element output and human safety is partial. Even after translating millions of finite element output vectors to a clear 3D graphic representation of deformations, strains and stresses, and even if the output is relatively accurate, it still does not relate directly to the consequences for the passengers. As said, there is a basic inability of finite element modeling to comprehensively analyze effects relating to a human body, even if a dummy modeling is included in the analysis.

Therefore, a hybrid approach is presented in this invention, in which the finite element analysis is only a part of the solution. The finite element model, based on this approach, can be simplified in many ways, because the desired output in most cases does not need to be very accurate, as the purpose is not to predict the exact output, but to compare output of different models. The required output can be described, in most cases, as qualitative, rather than quantitative. This means that simplified finite element analyses will eventually serve enhanced output, both in functionality and in accuracy, based on the method of the invention.

Another aspect of the finite element approach for this hybrid method is that the required output will never end up with a complex contour map representing millions of output vectors. If the output is not in the form of discrete parameters' values, it will be translated, with an extra postprocessing operations, to a set of discrete values, that will be used during the next steps.

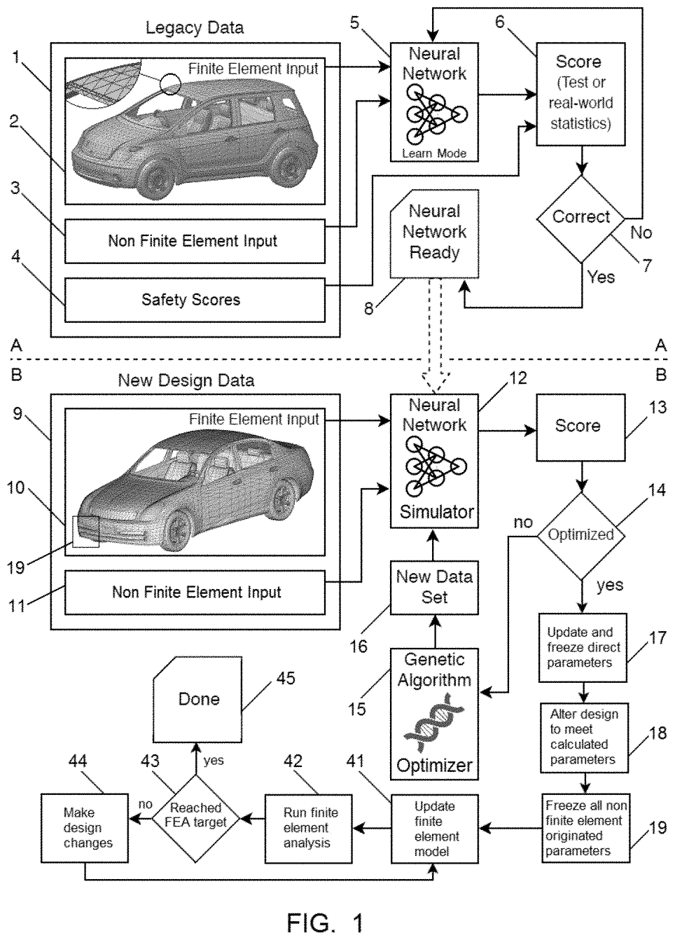

The method of the invention comprises the following steps:
a. Finite element related legacy input data definition:
The method begins with definition of the required input parameters which will be originated from finite element analyses. This also derives the required finite element modeling and solver methods. For example, the finite element related input data may be defined as the first two natural frequencies obtained from a car's full assembly model. A consistent methodology approach must be implemented. In the context of this invention, a consistent methodology approach means that the when defining the required input data that will be derived from a finite element analysis, it is crucial to define the exact finite element analysis process that will be repeated for all the cars in the legacy data, and later in the new design. The reason is that all models need to be comparable. Approximations that simplify the tasks are allowed and welcome, as the absolute accuracy of a model is less important than the consistency between all models. The consistent methodology must include the following:
   1. The geometry to be used as a basis to the finite element modeling must be consistent. For example, if the geometry includes the cars Body-In-White only, which is the automotive industry's definition for only the welded parts of a car, then all models must be based on the Body in White geometry.
   2. Element types and order must be consistent. All models must use the same meshing approach. For example, if the mesh of the hood of the cars in the database is based on linear triangle plate elements—this must be done for all models of all cars in the database. Although using parabolic triangle plate elements or linear quad plate elements would be more accurate, it should not be done if some of the models are based on a less accurate mesh. The consistency must be preserved.
   3. Typical mesh density must be consistent. The mesh size and the typical number of degrees of freedom must be consistent. For example, if a typical element length is 20 mm for some of the cars' models, other models with a 2 mm typical mesh size should not be used. It is not acceptable that, for example, two mesh models of a Body-In-White of two different SUV cars will have approximately 50,000 degrees of freedom for one model, and 1,000,000 degrees of freedom for the other model.
   4. Loads definition must be consistent. Any assumptions or methods must be applied to all models.
   5. Boundary conditions and, if applicable, also initial conditions, must be consistently defined. Any assumptions or methods must be applied to all models.
   6. Solvers to be used and such solvers' setup must be consistent. Same solvers and solution types must be applied to all models.
It should be emphasized that, as said, using this consistent methodology, it is possible to make significant simplifications relating to the models and to the solvers. This fact enables the finite element analyses step to be relatively fast and easy to implement, while obtaining effective and accurate outcome, due to said qualitative comparison approach which is implemented during the next steps.
It should be noted that in many cases, a special additional postprocessing calculation will be required, as demonstrated in the examples, in order to obtain discrete parameters' values that capture the finite element results. Finite element output typically consists of massive vectors' arrays, therefore such postprocessing may be required, to minimize the output to a set of parameters' values that can be used at the next steps.
b. Other parameters, non-finite-element-originated, legacy input data definition:
The required set of other parameters must be determined. Such other parameters can be, for example, specific dimensions, ratio between dimensions, center of gravity parameters, mass, and various design features. As said, the desired simulation goals may influence the selection of participating parameters.
c. Simulation goals definition:
It is required to define the simulation goals. Such goals may be crash test scores, or statistically based real-world scores, which are based on available statistics data relating to safety of existing cars.
d. Database creation:
Once the desired set of the input parameters (a) and (b) are determined, and the sets of the output goals (c) are defined, these parameters should be collected for as many as possible existing cars' models. Every car manufacturer has got already most of the data, available and ready to be used. Some of the data may require some additional processing before it becomes available. While this phase of database creation can be implemented by each cars' manufacturer separately, the method will be more powerful and effective if many manufacturers will share their data with each other. All the required input parameters are not an intellectual property, and there should be no barrier for such cooperation. A consortium or some other form of organization can collect the data from all manufacturers and make it available for all of them. Information relating to the statistics of real-world safety per each car's model is available at countries' transportation and public health authorities and should also be provided. Assembling such statistics data from many countries will increase the strength of the invention, so an international cooperation is preferred.
It would be preferred and recommended to arrange such database in groups and sub-groups, based on various categories, for logistics reason, and in order to support a systematic approach. Here are two examples:
   1. Data type: dimensions for example. A sub-category for dimensions may be (1a) external dimensions such as total length and total height; (1b) interior dimensions such as front head room or front leg room; (1c) other dimensions such as ground clearance. Another example of a data type may be dimensions' ratios such as height to length ratio.
   Yet another example of a data type may be physical properties such as mass and center of gravity location's coordinates. Additional, more complex calculated physical properties may be the ratio between the mass of metal parts of the car to the entire mass of the car, or the percentage of the car's mass which is located between the wheelbase.
   Yet another example of a data type may be a design feature, which is indicated with a Boolean yes/no value. For example: All-Wheel-Drive system. Some other features may have a variety of options which will be indexed with integer values. One example is the suspensions type which come in a wide variety of options such as MacPherson strut, Multi-link suspension, and more. Another example is a car type classification such as compact car, mid-size car, station wagon, roadster, compact SUV, mid-size SUV, etc.
   2. Data source: Arranging all parameters based on the data source would be very useful for obvious logistics reasons. Such data sources include, for example, (2a) Finite element analysis such as modal analysis; (2b) design parameters such as major dimensions; (2c) Safety crush test data such as frontal crush score.
   It should be noted that essentially, to be used in a neural network, all parameters must be transformed and normalized to decimal numbers in a specific range, even if they were originally integer numbers, or even Booleans. Moreover, the approach relating to integer parameters which represent design features might be somewhat different from the approach relating to other parameters, as farther discussed in example (2).
e. Artificial neural network definition:
Once all parameters' data sets are available for as many as possible car models, an artificial Neural Network should be defined. The number of the neurons of the input layer will be equal to the number of participant input parameters (a) and (b) as previously defined. The number of the neurons of the output layer will be equal to the number of participant output goals (c) as previously defined. The number of hidden layers and the number of neurons at each hidden layer can be defined based on any reasonable common practice, considering, for example, that too many layers are not desired due to a vanishing gradient problem (if using a gradient decent technique), while not enough layers would result in a non-effective solution. As said, such considerations, as well as other, relating to a definition of a neural network, are a common knowledge and will be decided during implementation of each specific algorithm.
f. Artificial neural network—learn mode:
Once the artificial neural network is created, the next step is the learn phase, as shown in FIG. 1A. All the collected input parameters and output scores relating to all existing cars' models are the legacy data (1), which is the database. The legacy data includes input parameters originated from finite element analyses (2), other input parameters which are not finite element originated (3), and related safety scores (4). The number of input parameters defines the number of neurons at the input layer of the neural network (5). During the learn mode, the neural network predicts the score values, and compares them to the goals' values in step (6). A correct result is defined as a score which is within a range of a predefined allowable tolerance from the desired goal. For example, a tolerance of 1% or less may be defined as a success indicator. As shown (7), if the results are not correct for all output parameters, the neural network performs another iteration. When all results are correct, the neural network is indicated as ready (8) to proceed to the next phase, which is a new design's simulation and optimization phase, as shown in FIG. 1B, which includes items (9) to (19) and (41) to (45), and as described hereinafter starting step (i).
It should be noted that if some of the input parameters of steps (2) and (3) are not relevant to the safety scores (4) after all, it will not affect the convergence to a solution of the neural network during the learn mode 1A, which is based on all the other parameters, as will be farther discussed in the examples. In the very unlikely case that all parameters (2) and (3) has no influence whatsoever on any of the safety scores (4), the neural network will not converge at all, which will be an indication that other parameters must be considered to be used for such neural network.
g. Finite element related input data for the new design:
This step includes a preparation of the finite element related analyzed data for the new car's design that needs to be optimized for safety. As said, the main principal is to be consistent with the finite element analysis process used for the legacy data, as defined in step (a) and collected in step (d). This includes the modeling guidelines, mesh types, typical meshing density, loads definitions, constraints methods, and solver types and setup. This consistency is important as the current design is practically compared to the legacy data cars using the neural network, and the input data should be based on same methodologies, assumptions and approximations.
h. Additional input data for the new design:
Values for the same type of parameters, as defined in step (b) and collected in step (d), should be defined and collected for the new design.
i. Simulation using initial design values:
The next phase is the design simulation. The neural network simulator (12), which has been calibrated during phase 1A, is now ready to receive input data (9) of a new car's design. As said, the finite element parameters (10) and the other parameters (11) include the initial values of the new design, as defined in steps (g) and (h). The simulator provides a score value or several score values (13) which relate to one or a more of the simulator's parameters of goals (6) as described in FIG. 1A. An optimized score value is predefined by the car's designer. For example, if the score parameter is frontal crash test safety, and the optimized value is defined as 5.0, and a success margin is defined as a tolerance of 5%, then any score bigger or equal to 4.75 will be accepted as an optimized score (14). If all output scores are optimized, then the design based on its initial values is optimized for safety and the process can proceed with step (17) as explained in stage (k) hereinafter. In most cases, however, the initial design values are not likely to be optimal for safety within the allowed tolerance, therefore the next step (15) of the genetic algorithm optimizer will begin.
j. Genetic Algorithm Optimizer:
It should be noted here, to prevent any possible confusion, that the neural network itself, during the learn mode (5), may use a genetic algorithm within the neural network, or, alternatively, the neural network may use a gradient decent approach instead. In any case, this has nothing to do with the optimizer which is described in this step (j) and marked as item (15), and which is a stand-alone genetic algorithm optimizer, that uses the already calibrated neural network (12) as a simulator for obtaining scores.
Within such genetic algorithm optimizer (15), the number of chromosomes per generation, as well as the implementation of crossovers and mutations, are a common knowledge and can be implemented based on any reasonable set of rules. The number of bits within a chromosome depends on the total amount of parameters, and the number of bits per parameter. The number of bits per parameter depends on the number of possible values of such parameter. For example, if the parameter is a frequency, having a range limit of 20 Hz to 40 Hz and a step of 0.1 Hz, then there are 10,000 possible values, therefore 14 bits are needed for this parameter. Said parameters are, of course, the same parameters used as the input for the neural network.
Assuming, for example, that 10 chromosomes are used per generation by the genetic algorithm (15), then such ten sets of parameters will be defined as a data set (16) and will be sent to the simulator (12). The genetic algorithm (15) will be defined to obtain each parameter only within its allowed range, which is based on the minimal/maximal allowed values, as required based on design considerations. The simulator (12) provides the scores sets. If any chromosome provides said optimized score (14), then the optimization phase (j) is complete and the design parameters of such chromosome are to be used for the design update step (k) as described hereinafter. If none of the 10 chromosomes is optimized (14), then the genetic algorithm (15) will create a new generation of chromosomes to be used as a new data set (16), using common genetic algorithm practices of sorting, cross over, adding new chromosomes and mutations. This new data set is sent again to the simulator (12). The process continues until a chromosome which reaches said optimized scores within said required tolerances is obtained.
It should be noted that there are additional ways to implement the optimizer (15). The optimization purpose is to obtain the score goals within a tolerance, as revealed by sending parameters to the simulator (12). The genetic algorithm is one way to perform such optimization. A simple example of another way to implement the optimizer is using brute force algorithm, though in most cases this approach is very inefficient. Yet another example, is to implement such optimizer based on a gradient decent algorithm.
k. Design Update:
Once an optimized set of parameters' values is obtained (14), a design update is required, using an iterative process as described in steps (17), (18), (19) and (41) to (45). First, all direct parameters' values are updated in the design and declared as frozen (17). Direct parameters are parameters that does not need to be calculated. For example: a design dimension of a car's length.
The second part of the iterative design update process is to calculate all indirect parameters if such parameters exist, except for the finite-element-originated parameters, which are the parameters of analyzed data. For example, if one of the optimized parameters is the x coordinate of the center of gravity of the car, then the current x coordinate of the center of gravity needs to be calculated, based on the updated design of step (17). If the calculated value is not identical to the optimized value within an accepted tolerance, then the design needs to be changed (18) and said parameter of center of gravity needs to be calculated again. Therefore, step (18) includes design changes in order to meet the optimized values for all said calculated parameters. It should be emphasized that the frozen parameters of step (17) must not be changed during step (18). When step (18) is complete, the calculated parameters' values are also declared frozen, so that all optimized parameters, except for the analyzed data of finite-element-originated parameters, have their finalized values (19).
The next and last iterative process of the design update phase (k) includes steps (41) to (44). The purpose is to nail all the optimized finite-element-originated parameters' values. The finite element model is updated (41) based on latest design updates (17) and (19). Then the finite element analysis is performed (42) in order to find the finite-element-originated parameters' values. If the finite-element-originated parameters reach their optimized value within an accepted tolerance than the process is done (45) and the new car's design is optimized for safety. If some or all of the finite-element-originated parameters do not reach their optimized value, then design changes are needed (44), as farther discussed in the examples. All frozen parameters of the previous steps (17) and (19) must be carefully kept during this step (44) of additional design changes.
Such iterative process of steps (41) to (44) continues until reaching the optimized parameters values (43). It should be noted that some finite element commercial packages support automation of such process of steps (41) to (44).

To summarize, the invention utilizes a flexible, modular and hybrid approach for cars' safety simulation, which will be demonstrated in the following examples (1) to (4). The terms flexible and modular in the context of the invention mean the ability to add or remove input parameters, as well as the ability to define various simulation goals. The term hybrid in the context of this invention relates to several aspects: (a) combining parameters resulting from a finite element analysis with other parameters; (b) the combined approach of using the finite element method and an artificial neural network and a genetic algorithm optimizer; (c) the ability to target both test scores and statistics based real-world scores; and (d) the ability of the method to expose safety parameters which relate both to solid mechanics formulation and to other unrevealed connections between car parameters and human safety.

This hybrid approach can enhance car's safety by introducing a simulation method which is superior in its functionality, in its accuracy and in its speed. It is possible to define simulation goals which bypass the crash testing score system and uses the neural network to predict real-world statistically based data that cannot be tested or simulated with any existing method whatsoever. It should emphasized that, as said, the overall resources of cost and time required for implementing the method of the invention are expected to be smaller than the resources used for existing safety prediction and optimization simulation methods.

The method of the invention will be farther explained and demonstrated hereby with various examples.

### EXAMPLE 1

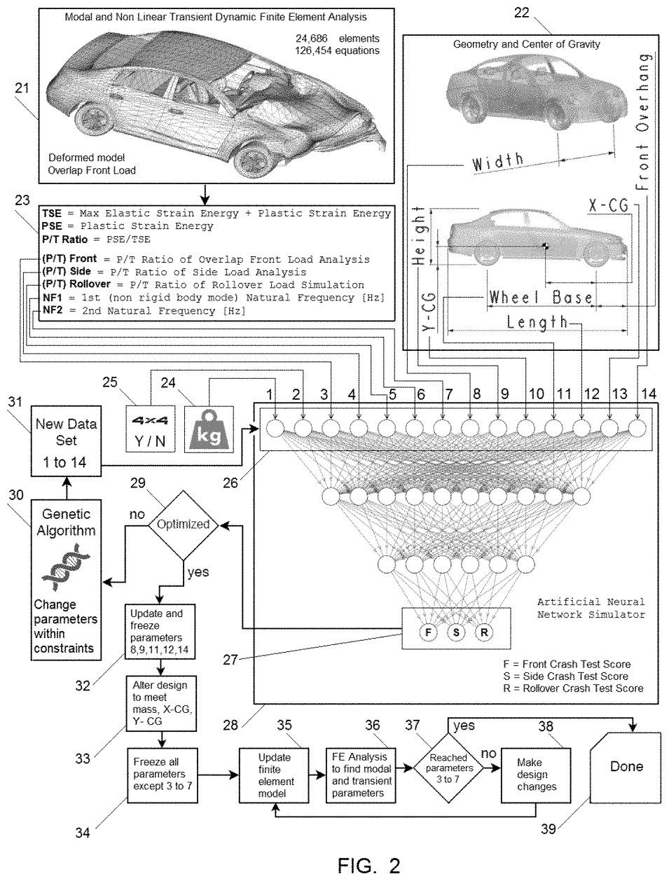

FIG. 2 shows the first example. The finite element part in this example includes both a modal analysis and 3 nonlinear transient dynamic finite element analyses. As said, the method of this invention enables significant simplification of the finite element solution, due to the qualitative comparison approach which is obtained using an artificial neural network. The first aspect of simplification in this example is the mesh density. The mesh of the car to be simulated in this example includes around 25,000 elements and around 125,000 degrees of freedom. The car's mesh, prior to analysis, is shown in the previous figure—FIG. 1, and marked as item (10). The element types used are mainly parabolic triangle plate elements. It should be noted that such car's assembly could be meshed with more than 500,000 elements and millions of equations for a standalone analysis, so the mesh used here is relatively course and supports a very fast solution, all according to the method of the invention.

The principles used to model and mesh this new car's design must be consistent with the entire database of legacy data, as said. During a pre-defined learn phase, all cars in the legacy data of the neural network must have been modeled in a similar fashion, meaning (a) the geometry used for all legacy cars included the entire car's assembly, with the wheels but without the glass windows; and (b) the element types used were parabolic triangle plate elements for all legacy cars; and (c) the typical mesh size or mesh density were similar to all cars, leading to around 20,000 to 30,000 elements and around 100,000 to 150,000 degrees of freedom.

4 Analyses are Performed for this Example:

(a) The first analysis is a normal mode analysis of the unconstraint model. The required output includes the natural frequencies of the first two non-rigid-body modes, in Hz, marked as NF1 and Nf2 at the finite element originated input list (23), and labeled as (6) and (7) at the input layer (26) of the neural network (28). In this case the finite element analysis directly provides discrete parameters' values, which are ready to go into the neural network (after normalization, of course), so no extra post processing of the finite element results is required.

(b) The second finite element analysis required for this hybrid simulator is a nonlinear transient dynamic analysis, which represents a passenger-side small overlap frontal test configuration. Such configuration is an industry standard for a test in which a car drives at 40 mph and hits a rigid structure that overlaps 25% of the front car, at the passenger's edge, marked as (19) in the previous figure—FIG. 1. The definition of the analysis as both non-linear and dynamic may imply, at first glimpse, that this is going to be a full-blown finite element analysis, of the type that this invention avoids as previously explained. However, this is not the case. The analysis is going to be a relatively simple analysis due to the following analysis techniques and approximations:

1. As said, the model, although representing most of the car's assembly, has a relatively small size in terms of number of nodes and elements.

2. The nonlinear definition of this model will be partial. Nonlinearity of large displacements will be defined. In addition, nonlinear materials will be defined, to capture the plastic strains and the nonlinear behavior of the metal structure when it exceeds its yield point. Other nonlinear aspects will be ignored, so no contact elements will be used.

3. The highly dynamic and complicated constraints and damping definitions will be replaced with the following simple approximated approach: the model will be constrained at its front corner as indicated (19) in the previous figure—FIG. 1. Such definition of boundary conditions represents the 25% percent overlap area of the passenger-side's small overlap frontal crash test configuration. The dynamic load to be applied is an initial velocity of 40 mph towards the front direction. Such combination of constraints and initial velocity serves as an approximation to the real dynamic problem, which does not provide accurate quantitative results, but it serves well the qualitative approach of comparison which is required for the invention. The dynamic solver selected for this example is Direct Transient. An overall structural damping coefficient of 0.04 is applied, which is a good practice for a car's welded structure. The time step is defined as 1/10 of the cycle time of the highest natural frequency to be considered for the dynamic excitation, as decided based on common knowledge in the field. If, for example, the first five non-rigid-body modes are to be considered, and the 5^{th} frequency is 50 Hz, then the time step will be set to 0.002. Such technique is a known finite element approximation, which, as said, is not accurate by its own, but it serves well the method of the invention, as long as all legacy data models are simulated using such same approach.

As said, according to the method of the invention, it is necessary to farther postprocess the output in order to obtain discrete parameters that capture the results and can be used as input for the neural network. The parameter that will be calculated here (23) is defined as

P/T Ratio=PSE/TSE

where:

TSE=maximal elastic strain energy+plastic strain energy

PSE=plastic strain energy

Both parameters refer to the strain energy of the entire model. The maximal elastic strain energy refers to the time step in which the model's elastic strain energy is maximal. The plastic strain energy refers to the final plastic deformation of the model.

The P/T Ratio for this small-overlap-frontal-load simulation is marked as (P/T) Front at the finite element input list (23) and labeled as (3) at the input layer (26) of the neural network (28).

(c) and (d): The 3rd and 4th finite element analyses are nonlinear transient dynamic analyses which represents a side crash test configuration and a rollover crash test configuration. Both utilize the same methods as used for the front crash simulation (b). The only differences are the direction of the initial velocity, which is side and top respectively, and the constraint nodes which applied to the side of the car and to the roof of the car respectively. The P/T ratio is calculated for each of these two additional analyses. The P/T Ratio for the side-load simulation is marked as (P/T) Side at the finite element input list (23) and labeled as (4) at the input layer (26) of the neural network (28). The P/T Ratio for the rollover-load simulation is marked as (P/T) Rollover at the finite element input list (23) and labeled as (5) at the input layer (26) of the neural network (28).

The non-finite-element-originated parameters include the following:
(a) The following external dimension (22) are used: Length (12), Height (9), Width (8).
(b) The following additional dimensions (22) are used: Wheelbase (11), Front Overhang (14).
(c) The following Center of Gravity dimensions are used: X-CG (13), Y-CG (10).
(d) The following physical property (24) is used: Mass (1).
(e) The following feature (25) is used: All Wheel Drive System Y/N (2).

To summarize, the input layer (26) of the neural network (28) includes 14 entries: items (3) to (7) which are originated from the finite element analyses parts (21) and (23), and items (1), (2), and (8) to (14) which are the non-finite-element parameters (22), (24), (25).

The neural network (28) as shown in FIG. 2 is already considered to be ready for simulation. In other words, FIG. 2 represents a detailed example of the simulation phase, as shown in FIG. 1B. It is therefore assumed that the learn mode, as shown in FIG. 1A, is already done.

In this example of FIG. 2, the neural network consists of two hidden layers, one with 10 neuron and the other with 6 neurons. The output layer (27) consists of 3 output neurons, all relate to crash test scores: F—passenger-side small overlap frontal crash test score; S—side crash test score; and R—rollover crash test score.

Once the initial design parameters (1) to (14) are entered to the neural network (28), it calculates the resulted scores (27). The decision whether the results are optimized or not (29) is based on the desired goals. If, for example, the goal for all scores is 5.0 within a tolerance of 2%, then all scores must reach a value of at least 4.9. If the results are not optimized, the genetic algorithm optimizer (30) is activated, and creates a new generation of data set (31) in order to seek for a member of said new data set with 14 design parameters which will meet the goals. Each parameter within the optimizer has constraints which limit its possible values' range. In some specific cases, the constraint must be fixed, and in most cases the constraint is defined with minimum and maximum values.

As an example of a fixed constraint: parameter (2) of the drive system will be fixed with a Boolean value of Y. This means that the simulated new car has a drive system type of AWD (25). When the neural network was in the learn mode, some of the legacy input date included AWD cars, and some other included FWD cars. Now, during the simulation of the new car, the specific value of such new car is entered. If, as suspected, this parameter of the drive system has any influence on the crash test scores, it will be revealed and considered by the simulator.

An example for min/max values is the car's Length. Based on functional design considerations, the designer defines the maximal and the minimal accepted values for the length. It is the responsibility of the designer to limit the min/max scope for all parameters, including some more complicated parameters such as natural frequencies or location of the center of gravity. However, if the designer does not have any pre knowledge or specific guidelines relating to narrowing the possible range for such values, he may define relatively large margins of min/max values. The only downside is that the optimizer may need more iterations until it converges to a solution.

The chromosome length of the genetic algorithm is defined using known techniques. For example, if the overall length of the car must be at least 4,000 mm, but not more than 4,150 mm, based on design considerations, and if the desired step is 1 mm, than there are 151 possible values, therefore 8 bits will be enough for a binary representation of all of this parameter's possible values. As said, this is a common knowledge of a genetic algorithm's definition. In this example, 8 bits will be assigned for each of parameters (8) to (14) which are the dimensions parameters, 14 bits will be assigned for each of parameters (3) to (7) which are the finite element originated parameters, 1 bit will be assigned to parameter (2), and 9 bits to parameter (1). Therefore, the chromosome length will be 144 bits.

If, for example, we define a generation size of 10, then the genetic algorithm optimizer (30) will create a new generation of 10 new chromosomes, resulting in a new data set (31) of 10 new sets of 14 parameter's values each, and use the simulator (28) to find 3 scores (27) to each of the 10 members in the data set. Based on such scores, the optimizer (30) will generate a new generation of 10 chromosomes using known practices of a genetic algorithm including crossover and mutation. This process will continue until reaching a generation in which one of the 10 sets of the new data set (31) leads to scores (27) that are optimized (29) based on said optimization criteria.

From this point, and based on the method of the invention, a series of several steps are required, in order to correlate the new design with the optimized parameters' values. In this example, these steps include the following steps (32) to (39), as shown in FIG. 2.

First, parameters (8), (9), (11), (12) and (14) are defined as frozen (32), meaning they are final and cannot be changed. These are the design parameters of length (12), height (9), width (8), wheelbase (11) and front overhang (14). These dimensions are driving parameters. The term driving parameters in the context of this invention refers to direct parameters, which do not need to be calculated. Once the driving dimensions are fixed, it is possible to move to next step of dealing with driven parameters. The term driven parameters in the context of this invention refers to parameters' values that are derived from other parameters and need to be calculated.

The next step (33) is making design changes in order to force the new design to meet the calculated required values of the mass (1), the center of gravity x coordinate (13) and the center of gravity y coordinate (10). The designer can make multiple design changes to reach such calculated values. For example: if the x coordinate needs to move in the x direction, the designer may change the location of the car's battery until reaching such goal. The only parameters which must not change during this step (33) are the direct parameters which have been declared as frozen at the previous step (32).

Once the design changes support the optimized values of parameters (1), (10) and (13), these 3 parameters are added to the frozen group of parameters, therefore all parameters except (3) to (7) are declared frozen (34) and must not be changed. Parameters (3) to (7) are the finite element analyzed parameters which have been left for the following final steps.

Based on optimized and frozen parameters (1), (2) and (8) to (14), the finite element model needs to be updated (35) in order to represent said dimensions and mass changes. Once the model is updated, the required analyses are performed (36): the modal analysis which obtains the natural frequency parameters NF1 and NF2, and the 3 nonlinear transient dynamic analyses which enable to obtain the 3 strain energy ratios (P/T) front, (P/T) side and (P/T) rollover.

These 5 analyzed parameters' values must reach their optimized value, as discovered in step (29). If all or some of these parameters' values are not correct, additional design changes will be made, in order to reach such values. For example, if the natural frequencies NF1 and NF2 are too low, the designer may want to add some stiffeners at strategic locations in order to increase the model's stiffness, so that the natural frequencies' values will increase. The designer has the freedom to make any design changes as long as the frozen parameters' values are kept. In said example, if a stiffener is added, some other changes are necessary in order to keep the mass (1) unchanged, as it is a frozen parameter from step (34). Similarly, while adding such stiffeners it is required to verify that the frozen values of the center of gravity location's parameters (10) and (13) remain unchanged.

After making such design updates, the finite element model is updated (35), the analyses are performed (36), and the results are checked again (37). If the results are not correct, the process of steps (35) to (38) repeats itself. Once analyzed parameters (3) to (7) reach their desired values, the entire design is declared as frozen and the process is done.

As said, that the following repetitive steps might be automated: (35) update finite element model, (36) analyze, (37) evaluate results and (38) update parameters' values while keeping frozen constraints unchanged. Some commercial finite element packages support such automated process.

When the process is done (39), the new design is optimized, and the car, once built, is expected to reach the highest frontal, side and rollover crash test safety scores.

### EXAMPLE 2

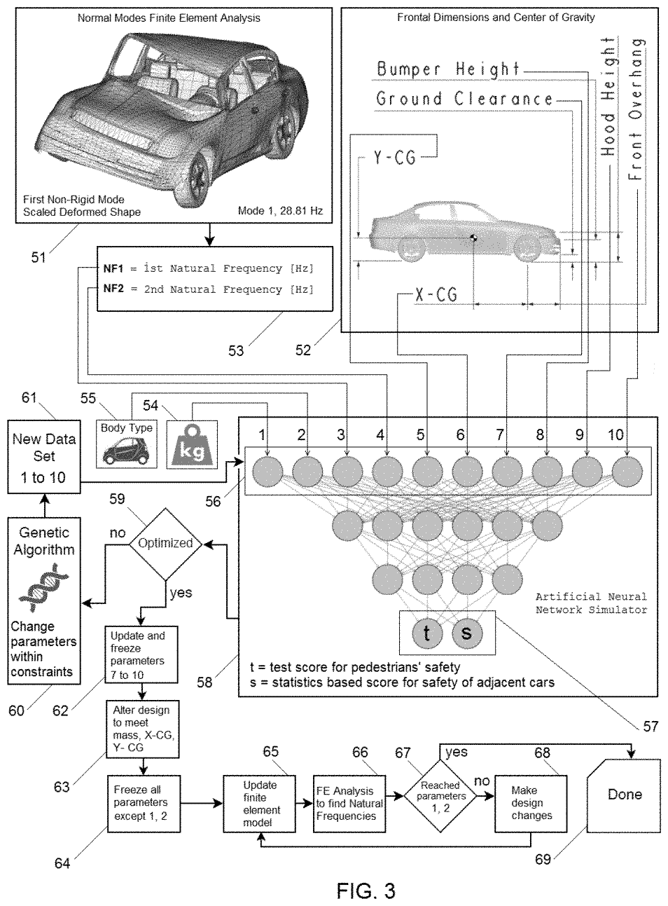

FIG. 3 shows the 2nd example. There are two optimization targets (57) in this example, indicated as (t): optimizing the car's design for pedestrians' safety test as indicated by crash test scores; and (s): optimizing the car's design for statistics-based safety score for passengers of adjacent cars which are involved in a crash situation with the optimized car. The second goal (s) is an example for the capability of the invention to simulate and optimize a new car based on safety aspects which cannot be simulated or tested using any existing method.

The finite element mesh is identical to the one used in example 1. However, only one analysis is performed for this example: a normal mode analysis of the unconstraint model. The first non-rigid-mode frequency in this example is 28.81 Hz, as shown in the deformed shape display (51). This frequency is marked as NF1 (53). Similar to the previous example, the required output from this modal analysis is the first two non-rigid-body-modes frequencies, in Hz, marked as NF1 and Nf2 at the finite element related input list (53), and labeled as (3) and (4) at the input layer (56) of the neural network (58).

The non-finite-element-originated parameters include the following:
(a) The following Center of Gravity dimensions are used: X-CG (6), Y-CG (5).
(b) The following dimensions, relating to the front part of the car, are used:

Ground Clearance (7), Bumper Height (8), Hood Height (9), Front Overhang (10).
(c) The following physical property (54) is used: Mass (1).
(d) The following feature (55) is used: Body Type (2).

The selection of said parameters' set (b) which include frontal dimensions (7), (8), (9), (10) is not arbitrary—it results from the assumption that the values of these dimensions might influence the safety score of a crash test in which a dummy representing a pedestrian is involved. Such assumptions, which are based on professional experience as well as common sense, increase the likelihood that the method will indeed reveal unknown significant correlations between design parameters and a cars' safety—correlations which could not be exposed without the method of the invention. However, such assumptions are not a must. Using state of the art computing power, and even super computers, it is possible to provide huge sets of parameters, and let the system find which parameters are important and in what way. The method of the invention is very flexible and modular. As such, the implementation might be of a very large scale on the one hand, using a very large set of input parameters and optimization goals, but on the other hand the implementation can be modest, and yet powerful, like in the current example, which includes only 10 input parameters, and 2 design goals.

To summarize, the input layer (56) of the neural network (58) includes 10 entries: analyzed items (3) and (4) which are originated from the finite element analysis parts (51) and (53), and items (1) ,(2) and (5) to (10) which are the non-finite-element parameters (52), (54) and (55).

The neural network (58) in FIG. 3 is already ready for simulation, i.e., as in the previous examples, FIG. 3 represents a detailed example of the simulation and optimization phase, as shown in FIG. 1B, and it is assumed that the learn mode, as shown in FIG. 1A, is already done.

In this example of FIG. 3, the neural network consists of two internal layers, one with 6 neuron and the other with 4 neurons. As said, the output layer (57) consists of 2 output parameters t and s.

Once the initial design parameters (1) to (10) are entered to the neural network (28), it calculates the resulted scores (57). The decision whether the results are optimized or not (59) is based on the predefined desired goals, within the predefined accepted tolerances. If the results are not optimized, the genetic algorithm optimizer (60) is activated.

In this example, parameter (2) refers to a body type (55). The value to be assigned here is an integer representing the body type of the car, according to conventions as defined in the database. For example, the convention might be that a compact size car is indicated with 1, a mid-size car—2, a compact SUV—3, etc. There are several ways to categorize cars to groups based on their type—there is no one standard way. Therefore, it is essential that one consistent set of car types' definition will be used along the entire database, and then during the simulation and optimization of the new car. In this example, the car type category definition includes 8 possible options. Therefore 3 bits will be assigned for this parameter (55), during the genetic algorithm step (60).

It should be noted that the expected change in the simulation results due to change of the car type is not a continuous change. This is different from a change in parameters like a dimension or a frequency, which can be defined in small steps representing a continuous change, thus expected to drive a continues change in the resulted scores. Including such non-continuous parameters in the neural network might result in convergence difficulties. Therefore, it is a preferred configuration of the invention to exclude such non-continuous parameter from the neural network and use it externally. Implementing this approach in this example means that the input layer of the neural network will include only 9 parameters. The body type will be excluded. Since there are 8 options for a body type, 8 neural networks will be generated, one for each body type. All 8 networks will be prepared during the learn mode, each with the part of the database that relates to the corresponding body type. Once a new design needs to be optimized, the neural network to be used will be the one associated with the new design's body type.

The genetic algorithm optimizer (60) creates a new generation of chromosomes, resulting in new data sets (61), and uses the simulator (58) to assign 2 scores (57) to each data set. Based on such scores, the optimizer (60) generates a next new generation of chromosomes using known practices of a genetic algorithm including crossover and mutations. This process continues until reaching a generation in which one of the new data sets (61) leads to scores (57) which are optimized (59) based on said optimization criteria.

The next steps ensure alignment of the new design with the optimized parameters. These steps include the following items (62) to (69), as shown in FIG. 3. First, the car's design is updated based on the direct parameters (7) to (10), which are now declared as frozen (62), meaning they are final and cannot be changed. These are the design parameters of ground clearance (7), bumper height (8), hood height (9) and front overhang (10).

The next step (63) is creating design changes in order to force the new design to meet the required calculated values of the mass (1), the center of gravity x coordinate (6) and the center of gravity y coordinate (5). The only parameters which must not change during this step (63) are the parameters which have been declared as frozen at the previous step (62).

Once the design changes support the optimized values of parameters (1), (5) and (6), these 3 parameters are added to the frozen parameters group, therefore all parameters except (3) and (4) are declared frozen (64) and must not be changed.

Based on the optimized and frozen parameters (1), (2) and (5) to (10), the finite element model needs to be updated (65) in order to represent the dimensions and mass changes. Once the finite element model is updated, the required modal analysis is performed (66), to obtain the natural frequency analyzed parameters NF1 and NF2, indicated as parameters (3) and (4).

These 2 parameters (3) and (4) must reach their optimized value, as discovered in step (59). Design changes will be applied in order to reach such values, and the designer has the freedom to make any design changes as long as the values of the frozen parameters (1), (2), and (5) to (10) are kept. After making such design updates, the finite element model is updated again (65), the analysis is performed again (66), and the results are checked again (67). If the results are not correct, design changes are required (68). The process of steps (65) to (68) repeats itself until the finite element output meets the optimized values of the natural frequencies' parameters (3) and (4). Then, the entire design is declared as frozen and the process is done (69). When the process is done the new design is optimized, and the car, once built, is expected to reach the highest pedestrian crash test safety score, and also to prove itself overtime to be best protecting, statistically, the passengers of other cars during crash situations.

### EXAMPLE 3

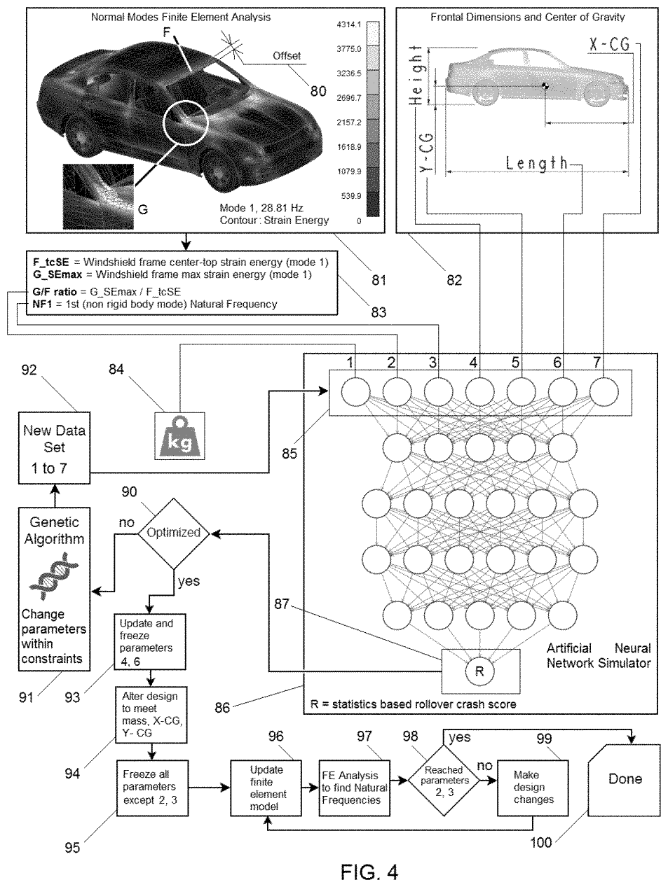

FIG. 4 shows example 3. There is only one optimization target (87) in this example, indicated as R: optimizing the car's design for rollover crash safety based on statistics data. This example demonstrates the ability to bypass test scores and optimize the car based on real-world data.

The finite element mesh is identical to the one used in examples 1 and 2. Similar to example 2, only one analysis is performed for this example: a normal mode analysis of the unconstraint model. The first non-rigid-mode frequency is marked as NF1 (83) and is one of the finite-element-related inputs (3) to be used for the input layer (85) of the neural network (86). However, in this example, additional output, which requires some additional postprocessing, is extracted from this analysis. The goal is a rollover crash safety, and, according to design experience as well as to common sense, the dynamic behavior of the frame of the windshield during such rollover crash situation is important. For the purpose of this analysis, the frame of the windshield is defined as all metal materials within an offset (80) of 2.5 inch from the windshield circumference. The strain energy contour map (81) of the first non-rigid-mode frequency is used to obtain two values of strain energy: one value is the maximum strain energy value within the entire 2.5-inch frame around the windshield. In this example it is located at point G as shown in the contour map (81) and labeled as G_SEmax (83). The second value is the strain energy value at the center-top area of the windshield frame, which is marked as F (81) and labeled as F_tcSE (83). These two values are not absolute but normalized during the modal analysis, however the required parameter will be calculated as the ratio between these two values:

G/F Ratio=G_SEmax/F_tcSE

Where, as said:

G_SEmax=windshield frame max strain energy of the first non-rigid mode.

F_tcSE =windshield frame center-top strain energy of the first non-rigid mode.

The rational of examining such ratio relates to the fact that it indicates how well the energy is distributed around the windshield's frame.

The non-finite-element-originated parameters include the following:
(a) The following external dimension (82) are used: Length (6), Height (4).
(b) The following Center of Gravity dimensions are used: X-CG (7), Y-CG (5).
(c) The following physical property (84) is used: Mass (1).

To summarize, the input layer (85) of the neural network (86) includes 7 entries: items (1) and (2) which are originated from the finite element analysis parts (81) (83), and items (3) to (7) which are the non-finite-element parameters (82) and (84).

The neural network (86) in FIG. 4 is already ready for simulation, i.e., as in the previous examples, FIG. 4 represents a detailed example of the simulation phase, as shown in FIG. 1B, and it is assumed, that the learn mode, as shown in FIG. 1A is already done.

In this example of FIG. 4, the neural network consists of 3 internal layers, one having 5 neuron and the other two with 6 neurons each. As said, the output layer (87) consists of one output parameter R.

Once the initial design parameters (1) to (7) are entered to the neural network (86), it calculates the resulted score (87). The decision whether the result is optimized or not (90) is based on the predefined desired goal, within the predefined accepted tolerance. If the result is not optimized, the genetic algorithm optimizer is activated. The genetic algorithm optimizer (91) creates a new generation of chromosomes, resulting in new data sets (92), and uses the simulator (86) to assign the correct score (87) to each data set. Based on that score, the optimizer (91) generates such new generation of chromosomes. This process continues until reaching a generation on which one of the new data sets (92) leads to score (87) which is optimized (90) based on said optimization criteria.

Similar to the previous examples, the next steps ensure a correlation of the new design with the optimized data set of parameters. These steps include the following steps (93) to (100), as shown in FIG. 4. First, the car's design is updated based on the direct parameters (4) and (6), which are now declared as final (93). These are the design parameters of length (6) and height (4). The next step (94) is creating design changes in order to force the new design to meet the required values of the mass (1), the center of gravity x coordinate (7) and the center of gravity y coordinate (5). The only parameters which must not change during this step (94) are parameters (4) and (6) which have been declared as frozen at the previous step (93).

Once the design changes support the optimized values of the calculated parameters (1), (4) and (6), these 3 parameters are added to the group of frozen parameters, therefore all parameters except (2) and (3) are declared frozen (95) and must not be changed.

Based on optimized and frozen parameters (1) and (4) to (7), the finite element model needs to be updated (96) in order to represent the dimensions and mass changes. Once the model is updated, the required modal analysis is performed (97), to obtain the natural frequency parameter NF1 and the related strain energy parameter G/F Ratio, indicated as parameters (2) and (3). These 2 parameters (2) and (3) must reach their optimized value, as discovered in step (90). Design changes will be applied in order to reach such values, and the designer has the freedom to make any changes as long as the optimized values of the frozen parameters (1) and (4) to (7) are kept. After making such design updates, the finite element model is updated again (96), the analysis is performed again (97), and the results are checked again (98). If the results are not correct, design changes are required (99). The process of steps (96) to (99) repeats itself until parameters (2) and (3) reach their desired values. Then the entire design is declared as frozen and the process is done.

When the process is done (100), the new design is optimized, and the car, once built, is expected to be optimized for rollover crash safety, and to prove itself overtime as best protecting, statistically, the passengers of the car during rollover crash situations.

### EXAMPLE 4

Example 4, which will be briefly presented here, in order to emphasize a few points relating to the invention, is a combination of the previous examples 2 and 3, which are illustrated in FIG. 3 and FIG. 4.

This combination example demonstrates how modular and flexible the method of the invention is.

Such combination of examples 2 and 3 means that:
a. The finite element originated input parameters include G/F ratio of example 3, NF1 which is common to both examples, and NF2 of example 2. A total of 3 parameters.
b. The other input parameters include the following parameters of example 3: Length and Height, the following parameters which are common to both examples: X-CG and Y-CG, and the parameters of example 2: Ground Clearance, Bumper Height, Hood Height, Front Overhang. A total of 8 parameters.
c. Additional input parameters include the Mass, which is common to both examples, and the Body Type of example 2. A total of 2 parameters.
d. Therefore, the input layer of example 4 includes 13 parameters.
e. In order to emphasize the flexibility and the generic characteristics of the invention, the scores to be found by the neural network in this example will not be defined as the combination of both examples, i.e. R of example 3, and t and s of example 2. Instead, the desired scores will be only R of example 3 and t of example 2. Therefore, the output layer of example 4 includes 2 parameters.
f. The rest of the differences are straightforward according to the method of the invention. Once the learn phase is done, the system can be used to optimize a new car's design. Once the optimizer provides the optimized set of said 13 parameters, a typical process as demonstrated in all previous examples is implemented, meaning freezing the direct parameters and updating the design based on the direct parameters' values, freezing the additional calculated parameters and updating the design based on the calculated parameters' values, updating the finite element analysis based on the updated design, and eventually reaching a new car's design which is aligned with all optimized values of the direct parameters, calculated parameters and analyzed parameters.

It should be noted that it is possible to create a massive system that may contain hundreds of input parameters and even more. The system also may be implemented to obtain a very large set scores, statistically based and test based. More resources of time and computer power will be needed for such approach, as said.

It should be emphasized that parameters which do not affect the scores will receive a weight which is close to zero during the learn mode of the neural network. For example: The Ground Clearance is one of the parameters included in example 4. If this parameter has no influence, after all, on the safety goals of example 4, then naturally it will get a zero or almost zero weight during the iterative process of the learn mode of the neural network. In this case, the neural network may be changed to exclude such parameter, however it is not a must. The presence of such parameter almost does not affect the performance.

If such parameter with no influence is identified but kept in the neural network, it is possible to assign a desired value for it and force such value to be fixed constraint value in the optimizer. However, even this operation is not a must. If such parameter of no influence gets a minimal and maximal values assigned into the optimizer, then the optimized set of parameters will include a random value for such parameter of no influence, which is within the allowed range.

While some embodiments of the invention have been described by way of illustration, it will be apparent that the invention can be put into practice with many modifications, variations and adaptations, and with the use of numerous parameters that are within the scope of persons skilled in the art, without departing from the spirit of the invention or exceeding the scope of the claims.

1. A computer implemented method for optimizing vehicles' design in terms of safety, comprising the steps of:
a) collecting design data sets which include values of design parameters of existing cars' models and values of parameters of related analyzed data;
b) collecting safety data sets of safety parameters' values of said cars' models;
c) creating an artificial neural network, such that values from said design data sets are used for the input layer and values from said safety data sets are used for the target output layer, such that the neural network learns how to reach from said input to said output, within predefined tolerances' values;
d) creating an optimizer in which the input is a new design data set, to be used for a new car's design, and defining ranges of possible values for such new data set, and defining safety goals based on said safety parameters, and using said neural network as a simulator, in order to find optimized values for said new design data set in terms of expected safety of said new car; and
e) based on such optimized values of said new design data set, performing a recurring process of freezing parameters' values and updating said new car's design, until all said optimized values are implemented in such new design.

2. Method according to claim 1 where said design data sets include direct design parameters.

3. Method according to claim 1 where said design data sets include calculated design parameters.

4. Method according to claim 1 where said analyzed data includes data of structural finite element analysis.

5. Method according to claim 4 where said finite element analysis includes specific postprocessing operations in order to obtain discrete parameters' values that can be used in said neural network's input layer;

6. Method according to claim 2 where said process of freezing parameters' values and updating the design accordingly includes one iteration relating to said direct parameters' values and a second iteration relating to said analyzed data.

7. Method according to claims 2 and 3 where said process of freezing parameters' values and updating the design accordingly includes one iteration relating to said direct parameters' values, a second iteration relating to said calculated parameters' values, and a third iteration relating to said analyzed data.

8. Method according to claim 1 where said process of freezing parameters' value and related design update is a recurring process which repeats itself until all parameters get their optimized final values.

9. Method according to claim 1 where said design data sets include dimensions, physical properties and material properties.

10. Method according to claim 1 where said design data sets include design features.

11. Method according to claim 1 which reveals dormant correlations between said design data sets and a car's safety.

12. Method according to claim 11 which reveals unknown correlations between said design data sets and the impact of a crash situation on the human body.

13. Method according to claim 1 where said safety data sets include crash test safety scores.

14. Method according to claim 1 where said safety data sets include real-world statistics data relating to safety of said cars' models and pedestrians during crash situations;

15. Method according to claim 1 where said safety data sets include real-world statistics data relating to safety of said cars' models and of passengers of adjacent vehicles during crash situations;

16. Method according to claim 1 where said range of possible values in the optimizer is narrowed to a constraint definition of a fixed value which is a design must.

17. Method according to claim 1 where said safety goals refer to crash test scores.

18. Method according to claim 1 where said safety goals refer to crash statistics data of real-world safety during crash situation.

19. Method according to claim 1 where weights of said neural network are being updated using a gradient decent method.

20. Method according to claim 1 where weights of said neural network are being updated using a genetic algorithm method.

21. Method according to claim 1 where a specific parameter of said design data sets will be excluded from said input layer of the neural network if such parameter's values are not continuous, and such resulted reduced-size neural network will be duplicated to the number of such non-continuous values, and each of the duplications will be adjusted to a different specific value from the group of said non-continuous values, based on a subset of said design data sets associated with such value, so it can be later used by said optimizer for a new car's design which has such specific value of said specific parameter.

22. Method according to claim 1 where said design data sets include present and past cars' models.

23. Method according to claim 1 where said optimizer uses a genetic algorithm.

24. Method according to claim 1 where said optimizer uses a gradient decent algorithm.

25. Method according to claim 1 where said optimizer uses a brute force algorithm.

26. Method according to claim 1 where said analyzed data includes simulated data of macro element analysis.

27. Method according to claim 1 with multiple optimization sessions during a new car's design cycle, each is based on existing partial design data set available at the time, such that said optimizer provides optimized design recommendation towards the next design phase, and towards such next optimization session, which will use an extended design data set.
